(19) United States
(12) Patent Application Publication
(10) Pub. No.: US 2025/0368582 A1
(43) Pub. Date: Dec. 4, 2025

(54) METHOD FOR MANUFACTURING A COMPOSITE MATERIAL PART

(71) Applicant: SAFRAN CERAMICS, LE HAILLAN (FR)

(72) Inventors: Yann HOSTEIN, MOISSY-CRAMAYEL (FR); William ROS, MOISSY-CRAMAYEL (FR); Denis VICIEN, MOISSY-CRAMAYEL (FR); Alexandre MARCHAIS, MOISSY-CRAMAYEL (FR)

(21) Appl. No.: 18/870,838

(22) PCT Filed: Jun. 1, 2023
(86) PCT No.: PCT/FR2023/050768

§ 371 Date: Dec. 2, 2024

(30) Foreign Application Priority Data
Jun. 3, 2022 (FR) FR2205361

(51) Int. Cl. C04B 41/50; C04B 41/45

(52) U.S. Cl. CPC C04B 41/5096; C04B 41/4523; C04B 41/457; C04B 2235/428

(57) ABSTRACT

A method for producing a part made of a ceramic matrix composite material, includes infiltrating a fibrous structure by dipping part of the fibrous structure in a bath of the infiltration composition, the infiltration composition including at least silicon in the molten state, and, before the infiltration, preparing the part of the fibrous structure intended to be dipped in the infiltration composition bath, the preparation including at least the application of a layer of an antiwetting composition, the antiwetting composition including a powder of an antiwetting agent of the impregnation composition in a mass content between 20% and 80%, the median particle size distribution of the antiwetting agent powder being between 1.0 μm and 50 μm.

### TECHNICAL FIELD

The invention concerns the field of manufacturing composite material parts, and more precisely those formed by a method of melt infiltration of a composition.

### PRIOR ART

Ceramic matrix composite materials (CMC), known for their good mechanical properties that make them suitable for constituting structural elements and for preserving these properties at high temperatures, constitute a viable alternative to traditional metal parts. Their reduced mass compared to their metal equivalent makes them the parts of choice to resolve the problems of increasing efficiency and reducing polluting emissions of engines in the aeronautical field.

Parts made of CMC material may comprise continuous fibrous reinforcement in the form of a woven textile, which is densified by a ceramic matrix. The fibrous reinforcement thus comprises long continuous fibers, the orientation of which can be adapted to the main directions of stress of the part during its use. The preform intended to form the fibrous reinforcement is woven from the continuous fibers to the dimensions of the part using a suitable loom.

In addition, it is known to obtain the matrix of these parts made of CMC material by the technique of melt infiltration. According to this technique, a molten composition, for example based on silicon in the molten state, can be introduced into the porosity of a fibrous structure comprising silicon carbide particles in order to form a ceramic matrix densifying the fibrous structure. In this technique, it is desirable for the molten composition to penetrate homogeneously and completely into the pores of the fibrous structure, so that the part obtained has a minimum residual porosity and therefore optimized mechanical properties. Generally, the molten silicon infiltrates the fibrous preform by capillary action, by dipping a small part of the fibrous preform in a liquid silicon bath.

However, some of the melt infiltration techniques do not give entirely satisfactory results, since the area of the preform placed in contact with the molten silicon bath may have a surface finish that does not allow it to comply with the allowable shape tolerances for the part. In addition, a degraded surface state makes any further processing step of the infiltrated part more difficult, for example the deposition of an environmental barrier with which such parts are generally coated.

To solve this problem, several solutions have been proposed. For example, sacrificial extra lengths can be provided, and removed after infiltration to achieve a part with an acceptable surface state. This first solution complicates the manufacturing method by imposing additional steps, and induces material losses which, multiplied by the number of parts, can represent a significant cost.

Another advanced solution is machining after infiltration of the part with a surface state degraded by infiltration to allow it to regain an acceptable state and to meet shape tolerances. This machining can be done by sandblasting, for example.

However, such machining is not desirable because, in addition to being expensive and time-consuming, it can lead to local deterioration of the part, which can lead to early wear of the part or mechanical characteristics that are lower than expected.

Another method for overcoming the problem mentioned above is infiltration of the preform without dipping it directly in the molten silicon bath, but rather by interposing a drain between the bath and the preform.

However, it was observed that this solution was not completely satisfactory, at least in that it did not fully address the problem of the degraded surface state of the parts thus obtained.

There is therefore a need for a solution that allows a preform to be impregnated with molten silicon free of one or more of the disadvantages described for the solutions of the prior art.

### DISCLOSURE OF THE INVENTION

To meet this need, the invention proposes a method for manufacturing a part made of a ceramic matrix composite material, comprising at least:
a step of infiltrating a fibrous structure by dipping part of the fibrous structure in a infiltration composition bath, said infiltration composition comprising at least silicon in the molten state;
the method being characterized in that it comprises, before the infiltration step, a step of preparing the part of said fibrous structure intended to be dipped in the infiltration composition bath, the preparation step comprising at least the application of a layer of an antiwetting composition, said antiwetting composition comprising powder of an antiwetting agent of the infiltration composition in a mass content comprised between 20% and 80%, the median particle size distribution of said antiwetting agent powder being comprised between 1.0 μm and 50 μm.

The treatment of the part of the fibrous structure dipped in the infiltration composition bath with an antiwetting composition prevents the infiltration composition from wetting the external surface of the fibrous structure and degrading its surface state.

However, it should be noted that the antiwetting composition does not harm the capillary phenomena necessary for the proper infiltration of the preform by the infiltration composition.

Moreover, the antiwetting composition also does not degrade the thermo-mechanical characteristics of the impregnated preform, and it therefore makes it possible to simplify the method for manufacturing a ceramic matrix composite material part very advantageously.

In the application, the terms “antiwetting composition” or an “antiwetting agent” should be understood in the usual sense of physical wetting between a surface and a liquid, the surface being here the surface of the fibrous structure and the liquid the infiltration composition. Wetting can be measured by the contact angle as usually defined, i.e. the tangent to the liquid at the air/liquid/surface interface point. The smaller the contact angle, the better the wetting.

From the preceding, and since an antiwetting agent has the purpose of reducing the wetting of the surface by the liquid, it follows that, for the purposes of the invention, an “antiwetting” agent is defined by its ability to increase the angle of contact between the infiltration composition and the surface of the fibrous structure.

In one embodiment, the antiwetting agent may be chosen from alumina, boron nitride, yttrium oxide, silica, silicon nitride or a mixture of several compounds chosen from the preceding list. Preferably, the antiwetting agent is boron nitride or yttrium oxide, or even yttrium oxide.

In one embodiment, the antiwetting composition may be applied by spraying, by dipping the fibrous structure in a bath of antiwetting composition, or by application with a brush.

As indicated, the step of applying the antiwetting composition is carried out on the part of the fibrous structure which is intended to be dipped in the infiltration composition bath.

In one embodiment, the portion of the fibrous structure that is to be dipped may be defined as a strip of width comprised between 1 mm and 10 mm from one end of the fibrous structure.

The inventors have found that this choice for the part of the fibrous structure in contact with the infiltration bath makes it possible to ensure that the surface of the fibrous structure immersed in the infiltration composition bath can achieve good capillary rise of the infiltration composition throughout the fibrous structure.

In one embodiment, each step of application of the antiwetting composition may be followed by a drying step.

For example, such a drying step can be done in air or in an oven.

For example, the drying step can last between 5 minutes and 30 minutes.

In one embodiment, the preparation step comprises the succession of a step of applying a layer of the antiwetting composition and a drying step one or more times.

The application of several layers of the antiwetting composition ensures that the entire area of interest, i.e. the part of the fibrous structure dipped in the infiltration composition bath, is covered with at least one layer of the antiwetting composition.

Indeed, the thickness of the antiwetting composition applied has little influence on obtaining the technical effect, but it is preferable that the entire part of the fibrous structure immersed in the infiltration composition bath be covered with at least one layer of antiwetting composition.

In one embodiment, the antiwetting composition comprises a powder of an antiwetting agent for the alloy in a mass content comprised between 20% and 40%.

Indeed, the inventors have observed that the reduction in the mass content of the antiwetting agent makes it possible to obtain a good compromise between the effect obtained and the cost of the antiwetting composition.

In one embodiment, the antiwetting composition may comprise a powder of a solvated antiwetting agent. For example, the solvent of the antiwetting composition may be water, or an alcohol such as ethanol.

In one embodiment, the median particle size distribution of the powder of an antiwetting agent is comprised between 1.0 μm and 20 μm.

The median particle size distribution of the powder is understood in the present application as the median number value, also called D50, around which the diameters of the particles of the powder extend.

In one embodiment, the particle size distribution may be measured by statistical counting, for example, on images acquired by scanning electron microscopy. This method is given as an indication and any other method allowing statistical counting and determination of the particle size distribution may be used for the purposes of the invention.

The inventors have found that the particle size distribution proposed makes it possible to further improve the antiwetting properties of the antiwetting composition.

In one embodiment, the antiwetting composition may be removed between the step of applying the antiwetting composition and the infiltration step.

Indeed, to obtain an improved surface finish compared to the materials of the prior art, it is not necessary for the antiwetting composition to modify the surface finish of the preform.

In one embodiment, and unlike the prior art solution, which would propose a physical modification of the surface state of the preform before the infiltration of molten silicon, for example by forming a smoother layer on the surface of the preform, it can be noted that the infiltration composition does not modify the surface state of the preform.

The application of the antiwetting composition only modifies the wetting properties of the fibrous preform.

Without wishing to be bound by theory, the inventors have found that it is precisely the modification of these wetting properties that allow the improvement of the surface state observed by means of the method of the invention. In one embodiment, the infiltration of the preform may be preceded by a slurry-cast infiltration step comprising ceramic and/or carbon particles.

Such slurry-cast infiltration, prior to silicon melt infiltration, is well known to those skilled in the art and makes it possible to form a ceramic matrix.

In one embodiment, the infiltration composition may be selected from pure silicon in the molten state, or a silicon alloy in the molten state.

In one embodiment, the fibrous structure is a fibrous preform of a turbomachine part.

In one embodiment, such a turbomachine part may, for example, be a fibrous preform of a turbomachine vane or blade, of a ring sector or of a combustion chamber.

In one embodiment, the part of the fibrous structure dipped in the infiltration composition bath is the part of the fibrous structure intended to form the root of a turbomachine blade.

The inventors have found that the method of the invention is particularly suitable for turbomachine blades, and even more so when the part intended to form the root of the blade is dipped in the infiltration composition.

Indeed, the method of the invention makes it possible to obtain the effects described above for such parts which are most likely to be made by melt infiltration.

In addition, the roots of turbomachine blades must comply with tight tolerances in terms of shape and surface state, which the method of the invention makes it possible to obtain, thus allowing a simpler and more economical method than the methods of the prior art for obtaining turbomachine blades made of CMC. Indeed, it makes it possible to avoid providing sacrificial excess material and carrying out machining steps after infiltration to restore the surface state.

### BRIEF DESCRIPTION OF THE DRAWINGS

FIG. 1 schematically represents a device allowing the infiltration of a preform via a method according to the invention.

FIG. 2 is a photograph of a part obtained by a method according to the invention.

FIG. 3 is a photograph of a comparative part obtained by a method outside the invention.

### DESCRIPTION OF THE EMBODIMENTS

The invention will now be described by means of figures, which are present for descriptive purposes to illustrate certain embodiments of the invention and which should not be interpreted as limiting the invention.

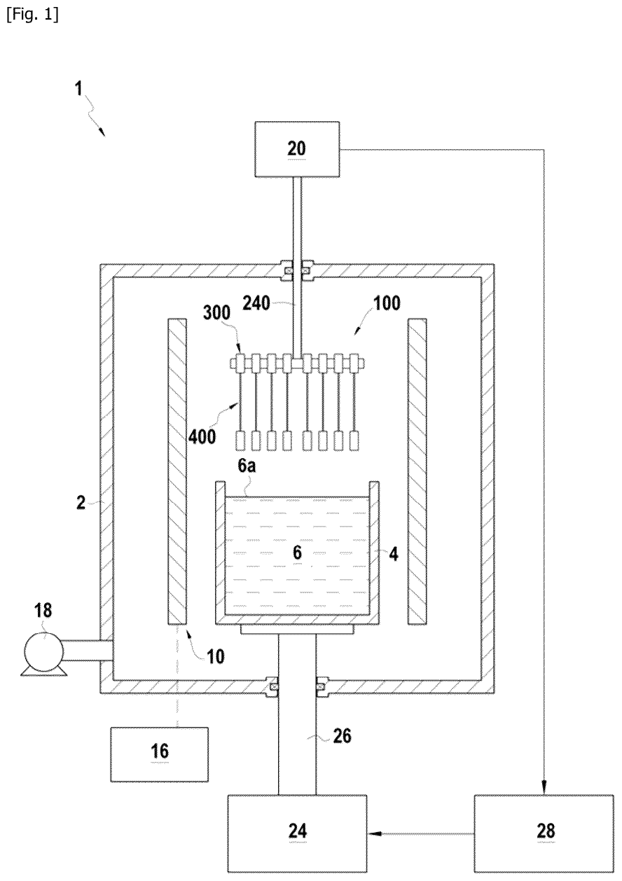

FIG. 1 shows a sectional view of a furnace 1 that can be used in the infiltration step of a method for manufacturing a CMC part according to the invention. The furnace 1 comprises a hermetic chamber 2 inside which are present a crucible 4 having an internal volume containing an infiltration composition 6, and a support tool 100 comprising a plurality of individual supports 300 each loaded with a fibrous structure, here a porous turbomachine blade preform 400 shown very schematically, the plurality of individual supports 300 being held in a single cluster 100, the cluster 100 further comprising a support arm 240.

The crucible 4 may be made of a ceramic material. The infiltration composition 6 may, for example, be silicon or a silicon alloy. The furnace 1 is here provided with a resistive heating system 10, for example comprising graphite bars. The heating system 10 is disposed around the crucible 4 and the preform 400 in the chamber 2 of the furnace 1. In a known manner, the heating system further comprises a generator 16 so as to supply the heating system. The furnace 1 may also be provided with a vacuum pump 18 in fluid communication with the interior of the chamber 2, so as to carry out the vacuum infiltration process. It should be noted that another type of furnace than the one illustrated can be used, in particular the furnace can comprise an inductive heating system instead of a resistive system.

The furnace 1 comprises a device for measuring the mass of the preforms 400 corresponding here to a scale 20 of the load cell type. In this example, the scale 20 is located outside the chamber 2 of the furnace 1, above the chamber 2. Naturally, other mass measuring devices can be used without exceeding the scope of the present invention.

The furnace 1 further comprises a displacement device comprising here a cylinder 24 having a rod 26 on which the crucible 4 is mounted. In this example, the cylinder 24 is located outside the chamber 2 of the furnace 1, below the chamber 2. In this way, the cylinder 20 makes it possible to move the crucible 4 with a vertical translation movement inside the chamber 2 of the furnace 1, especially in the direction of the porous preforms 400. Thus, the crucible 4 is movable in vertical translation in the chamber 2. In a variant (not shown), the crucible may be mounted stationary in the furnace, and the preform may be movable in vertical translation.

In the example illustrated, the furnace 1 also comprises a system 28 for controlling the relative position between the preforms and the crucible, which system is configured to control the cylinder 24 as a function of the evolution of the mass of the preforms 400 as measured by the scale 20 supporting all the preforms 400 via the support arm 240. This control system 28 can be, for example, an automaton or a computer equipped with an input/output acquisition card. The control system 28 can receive electrical signals coming from the scale 20 at its input and send control signals to the cylinder 24 at its output.

The porous preforms 400 are infiltrated by bringing said preforms 400 into contact with the surface 6a of the infiltration composition 6, which may, for example, be silicon or a silicon alloy, the infiltration composition 6 infiltrating the porosity of the preforms by capillary action. During contacting, the lower part of the preforms 400 is directly dipped in the bath of infiltration composition 6, which composition is then conveyed into the preforms 400 by capillary action. Controlling the cylinder 24 controls whether the preforms are in contact with the infiltration composition 6 and, consequently, controls the infiltration of the preforms by the infiltration composition 6. The infiltration of the preforms 400 by the infiltration composition 6 ends when the scale 20 measures a predetermined mass build-up corresponding to the desired level of densification for the preforms 400. Parts are then obtained, made of CMC material comprising a fibrous reinforcement densified by a matrix.

To carry out a method according to the invention, the lower part of the preforms 400 are covered with an antiwetting composition before the infiltration that has just been described.

To characterize the effects of the preparation step of a method according to the invention, two turbomachine blade preforms were infiltrated with molten silicon. One preform was prepared according to a method of the invention and the other according to a method outside the invention, in all respects identical to the method of the invention except that the second preform has not undergone a preparation step, i.e., it has not been covered with an antiwetting composition.

For this example, the antiwetting composition is a composition comprising 30% by mass of boron nitride powder whose median particle size is 10 μm, the remainder of the composition being a mixture of acetone, butane, propane and butanone acting as solvent.

The antiwetting composition is deposited on the root area of a blade, which root area is then immersed in a bath of molten silicon.

The two parts were then compared visually.

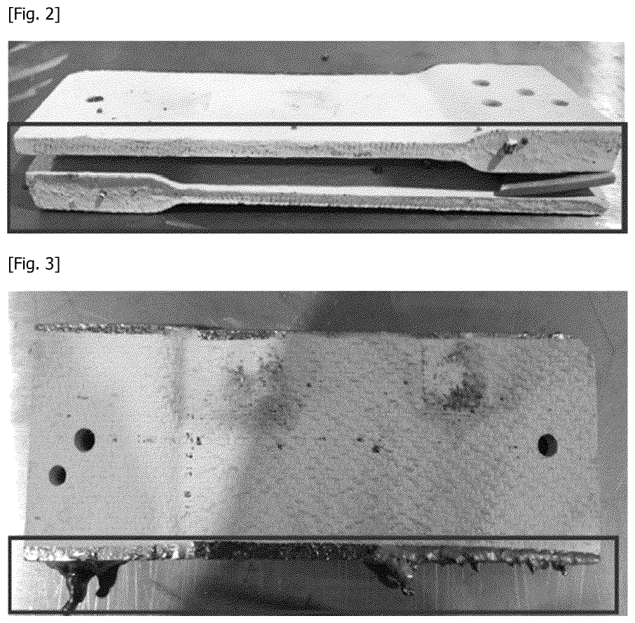

FIGS. 2 and 3 are photographs of the two parts impregnated according to a method of the invention (FIG. 2) and according to a method outside the invention (FIG. 3).

The box on the photographs identifies the area of the part that has been immersed in the molten silicon bath.

It can be noted by comparing FIGS. 2 and 3 that the implementation of the invention makes it possible to obtain a part whose surface state is much smoother than that of the part infiltrated according to the method outside the invention.

To ensure that the presence of the antiwetting composition did not hinder the proper infiltration of the part by the molten silicon, the densities of the two parts were compared, and are in both cases equal.

Thus, this example shows that carrying out a method according to the invention makes it possible to obtain a part whose surface state is greatly improved, without hindering the proper infiltration of the infiltration composition into the part.

1. A method for producing a ceramic matrix composite part, comprising:
infiltrating a fibrous structure by dipping part of the fibrous structure in a bath of the infiltration composition, said infiltration composition comprising at least silicon in the molten state,
before the infiltrating, preparing the part of said fibrous structure intended to be dipped in the infiltration composition bath, the preparing comprising at least application of a layer of an antiwetting composition on an external surface of the fibrous structure, said antiwetting composition comprising a powder of an antiwetting agent of the infiltration composition in a mass content comprised between 20% and 80%, a median particle size distribution of said antiwetting agent powder being comprised between 1.0 μm and 50 μm, and wherein the antiwetting agent is chosen from alumina, boron nitride, yttrium oxide, silica, silicon nitride or a mixture of several compounds chosen from the preceding list.

2. (canceled)

3. The method according to claim 1, wherein the preparing comprises the succession of a step of applying a layer of the antiwetting composition and a drying step one or more times.

4. The method according to claim 1, wherein the antiwetting composition is applied by spraying, by dipping the fibrous structure in a bath of antiwetting composition, or by application with a brush.

5. The method according to claim 1 4, wherein the antiwetting composition comprises a powder of an antiwetting agent for the alloy in a mass content comprised between 20% and 40%.

6. The method according to claim 1 1, wherein the median particle size distribution of the antiwetting agent powder is comprised between 1.0 μm and 20 μm.

7. The method according to claim 1, wherein the fibrous structure is a fibrous preform for a turbomachine part.

8. The method according to claim 1, wherein the fibrous structure is a fibrous preform for a turbomachine vane or blade, or a ring sector or of a combustion chamber.

9. The method according to claim 8, wherein the part of the fibrous structure dipped in the bath of the infiltration composition is the part of the fibrous structure intended to form the root of a turbomachine blade.
